(19) United States
(12) Patent Application Publication
(10) Pub. No.: US 2011/0159934 A1
(43) Pub. Date: Jun. 30, 2011

(54) HANDHELD DEVICE

(76) Inventors: Wen-Ping Yu, Taipei County (TW); Tung-Po Chiu, Taipei County (TW)

(21) Appl. No.: 12/837,523

(22) Filed: Jul. 16, 2010

(30) Foreign Application Priority Data
Dec. 31, 2009 (TW) 098146608

(51) Int. Cl. H04W 88/02

(52) U.S. Cl. 455/575.4

(57) ABSTRACT

A first housing and a second housing of a handheld device are capable of sliding with respect to each other such that the first and the second housings can be positioned in different using positions and thus the handheld device can be configured at corresponding using statuses. The first housing includes a first magnetic element and the second housing includes a plurality of second magnetic elements aligning along a direction. The second magnetic elements having one polarity and the second magnetic elements having another polarity are disposed alternately. When the second housing slides on the first housing to a position where the first magnetic element faces a second magnetic element with opposite polarity, the handheld device is configured at a corresponding using status.

### BACKGROUND OF THE INVENTION

1. Field of the Invention

The invention relates to a handheld device, and more particularly, to a slider handheld device having upper and lower covers with magnetic elements to automatically position to different predetermined positions.

2. Description of the Prior Art

Recent handheld devices (such as mobile phones) with upper and lower housings are capable of sliding to an opened position or a closed position via horizontal movement between the housings. The handheld devices have different functions and applications as set in the opened position and in the closed position. To make the housings of the handheld devices slide with respective to each other, slideways between the upper and lower housings are usually disposed there between, where a first slideway is disposed on the upper housing (usually referring to the sliding cover of the handheld device) and a second slideway is disposed on the lower housing (usually referring to the main body of the handheld device) to cooperate with the first slideway, which practically can be combination of a slider and a rail, such that the upper housing may be pushed by a user and slide in or out with respective to the lower housing.

To make the sliding cover of the handheld device move conveniently, a hinge with dual automatic reversion function is designed in the slideway device between the upper and the lower housings in the current technology: when the upper housing is pushed beyond a predetermined travel, the slideway device drives the upper housing automatically to the opened position (or to the closed position). The sliding cover may slide to the predetermined position automatically without being manually pushed by the user to the longest travel. A slideway device is disclosed in the Taiwan patent#M291155, where two semicircular arc-shaped traction springs are disposed between the upper and the lower covers of the mobile phone, and each two ends of the traction springs are connected to the upper and the lower covers respectively. When the upper and the lower covers of the mobile phone slide relatively, the contour of the traction springs are changed by the upper and the lower covers, and afterward the recovering force caused by the traction springs pushes the upper cover automatically to the opened or the closed position (according to whether or not the relative movement of the upper and the lower cover pushed by outer force exceeds a critical value of the traction springs). Therefore, additional mechanical components are utilized to realize the automatic reversion function.

Such kind of hinge structure allows two structural components, which connect to each other via the hinge structure, to open and close relatively. The more far the upper cover slides away relative to the lower cover, the larger area of the handheld device can be exposed for use. The extent of the two covers sliding away from each other, however, has limitation due to the fact that the hinge structure occupies quite a few rooms in the handheld device, plus the need for the hinge to move and deform. Generally, the upper housing is allowed to move with respective to the lower housing until the lower housing exposes half of its surface area, ⅔ of its area being the most but rare case. Besides, the slideway devices between the upper and the lower housings are used as a supporting structure. Hence, the rigidness of the supporting structure between the upper and the lower housings turns weaker as the upper housing and the lower housing slide away from each other.

### SUMMARY OF THE INVENTION

The present invention provides a handheld device having a plurality of using statuses, and the handheld device includes a first housing and a second housing. The first housing includes a first magnetic element, and the first housing assembles with the second housing in a sliding manner with respect to the second housing along an operating direction. The second housing includes a plurality of second magnetic elements disposed along the operating direction and opposite to the first magnetic element, and the plurality of second magnetic elements have identical and opposite polarities arranged successively. The first housing and the second housing are capable of being configured at a plurality of corresponding using positions according to the using statuses of the handheld device. The first housing and the second housing are configured at a corresponding using position when the first housing slides along the operating direction with respect to the second housing to a position where the first magnetic element faces one of the second magnetic elements with opposite polarity. The first housing and the second housing are pushed to a using position by magnetic repulsive force when the first housing slides along the operating direction with respect to the second housing to a position where the first magnetic element faces one of the second magnetic elements with the same polarity.

The present invention also provides a handheld device having a plurality of using statuses. The handheld device includes a first housing and a second housing. The first housing includes a first magnetic element. The second housing is disposed on the first housing in a sliding manner along an operating direction, and the second housing includes a plurality of second magnetic elements disposed along the operating direction with alternating polarities. The plurality of second magnetic elements having polarities arranged alternatively with respect to the first magnetic element generates attractive and repulsive forces so as to push the first housing and the second housing to a specific position when the first housing slides with respect to the second housing along the operating direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a partial perspective front view of a handheld device set in the opened status according to a first embodiment in the present invention.

FIG. 2 is a schematic diagram of a side sectional view of the handheld device set in the opened status according to the first embodiment.

FIG. 3 is a schematic diagram of a partial perspective front view of the handheld device set in the closed status according to the first embodiment.

FIG. 4 is a schematic diagram of a side sectional view of the handheld device set in the closed status according to the first embodiment.

FIG. 5 is a schematic diagram illustrating attractive forces and repulsive forces between the magnetic elements of the two housings when the second housing of the handheld device is pushed to a different position by external force in the first embodiment.

FIG. 6 is a schematic diagram of the handheld device according to a second embodiment in the present invention.

FIG. 7 is a schematic diagram of the handheld device according to a third embodiment in the present invention.

FIG. 8 is a schematic diagram of the handheld device according to a fourth embodiment in the present invention.

### DETAILED DESCRIPTION

The present invention utilizes the characteristic of the repulsion between like poles and attraction between unlike poles (the attractive force or the repulsive force is stronger when two magnets approach each other, the attractive force or the repulsive force is weaker when two magnets depart) to achieve the automatic reversion function when an upper and a lower housings of a slider handheld devices slide with respective to each other. The greater extent the upper housing opens relatively to the lower housing (and to fully opened status), the stronger the attractive force of magnetic elements becomes, such that there is better support between the upper and the lower housings in the opened status. In this application, the slider reversion elements (the magnetic elements) and the structural slideways between the upper and the lower housings are independent components, i.e., the structural slideways are utilized to set the directions and number of dimensions, wherein the upper and the lower housings can slide with respect to each other in these directions, and the magnetic elements are utilized to generate reversion force. Therefore, the structural slideways of the handheld devices can further reduce in the size and the space it occupies in the upper and the lower housings so that the upper housing and the lower housing may slide away from each other for a greater extent.

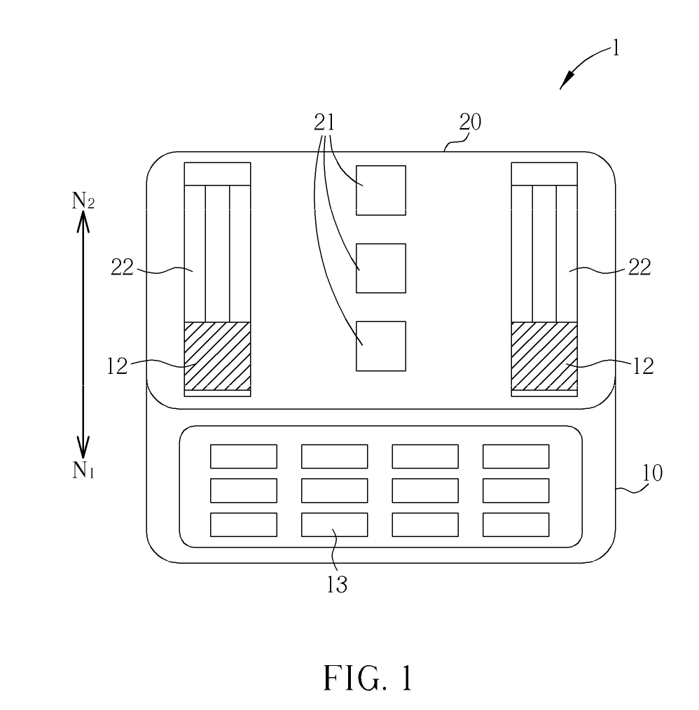

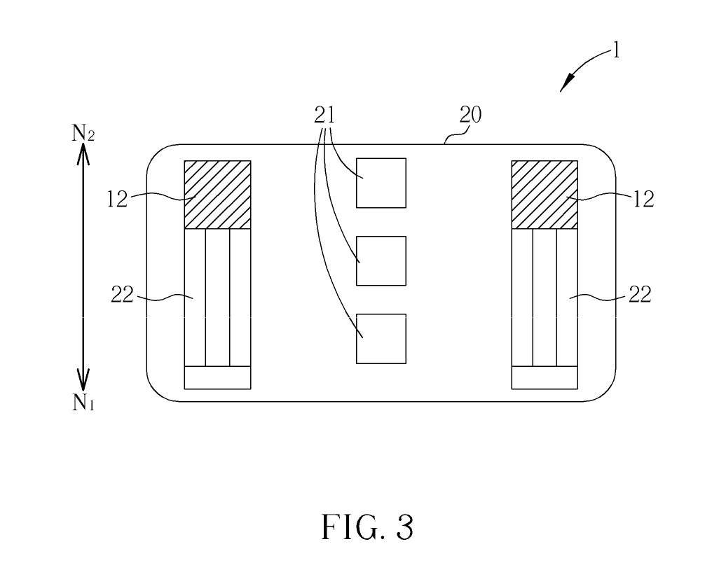

Please refer to FIG. 1. FIG. 1 is a schematic diagram of a partial perspective view of a handheld device 1 set in the opened status according to a first embodiment in the present invention. The handheld device 1 includes a first housing 10 and a second housing 20, wherein the first housing 10 and the second housing 20 are capable of sliding with respective to each other to the opened status or the closed status. Practically, the first housing 10 can be a main body of a slider phone, and the second housing 20 can be a sliding cover of the slider phone. A first keypad 13 or other components can be disposed in the first housing 10, and a screen or other components can be disposed in the second housing 20, and they will not be described herein for brevity. Please also refer to FIG. 3. FIG. 3 is a schematic diagram of a partial perspective front view of the handheld device set in the closed status according to the first embodiment. In the first embodiment, the sliding of the handheld device 1 makes the handheld device 1 have the opened status as shown in FIG. 1 or the closed status as shown in FIG. 3. Two second slideways 22 (vertical rails with slots in the middle in this embodiment) along N₁N₂ direction (or the operating direction of the handheld device 1) are disposed at two sides of the second housing 20 respectively. Two first slideways 12 (pulleys in this embodiment) are disposed at two sides of the first housing 10 corresponding to the second slideways 22. The first slideways 12 cooperate with the second slideways 22 to make the handheld device 1 move between the opened status and the closed status when the first slideways 12 move in the middle slots of the second slideways 22.

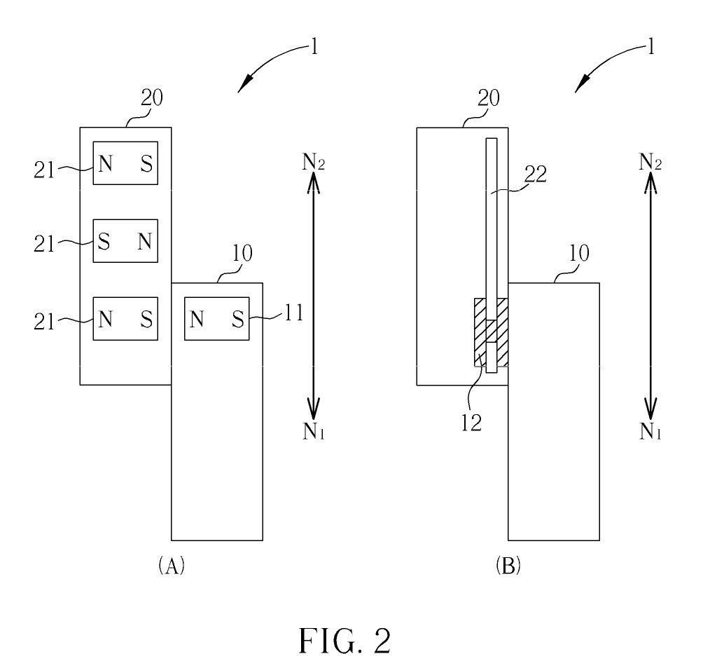

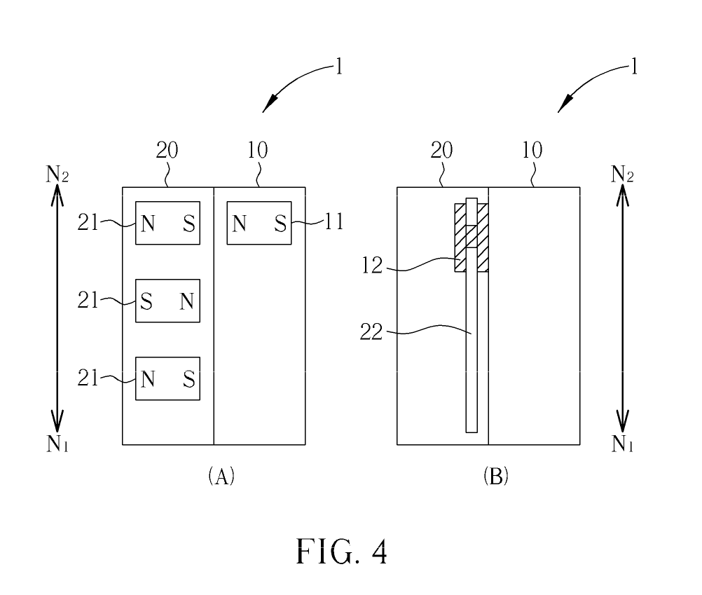

Please refer to FIG. 2 and FIG. 4. FIG. 2 is a schematic diagram of a side sectional view of the handheld device 1 corresponding to FIG. 1. FIG. 4 is a schematic diagram of a side sectional view of the handheld device 1 corresponding to FIG. 3. Wherein the portion B of FIG. 2 is a schematic diagram of the corresponding position of the slideway 12 and the portion B of FIG. 4 is a schematic diagram of the corresponding position of the slideway 22. In the portion A of FIG. 2 and the portion A of FIG. 4, the first housing 10 includes a first magnetic element 11 at one side, and the magnetic polarity of the first magnetic element 11 is shown. The middle vertical portion of the second housing 20 (referring to FIG. 1 and FIG. 3) includes three second magnetic elements 21, the second magnetic elements 21 align along the N₁N₂ direction of the sliding cover, and the magnetic polarity of the second magnetic elements 21 is shown. Additionally, as the first magnetic element 11 slides on the second housing 20, there is attractive force or repulsive force between the first magnetic element 11 and the second magnetic elements 12 according to the polarity of the corresponding second magnetic element 12 that the first magnetic element 11 faces as the first magnetic element 11 slides to a certain position. In FIG. 2 and FIG. 4, the second magnetic elements 21 are all aligned on the same side of the first magnetic element 11 and have polarities alternatively identical and opposite to polarity of the first magnetic element 11. In the opened status of FIG. 2, the first housing 10 and the second housing 20 are disposed in an opened using status, and the first magnetic element 11 faces the second magnetic elements 21 with opposite polarity such that an attractive force is generated to keep the handheld device 1 in the opened status steadily. As for the closed status in FIG. 4, the first housing 10 and the second housing 20 are disposed in closed using status, and the first magnetic element 11 faces the second magnetic elements 21 with opposite polarity such that an attractive force is generated to keep the handheld device 1 in the closed status steadily.

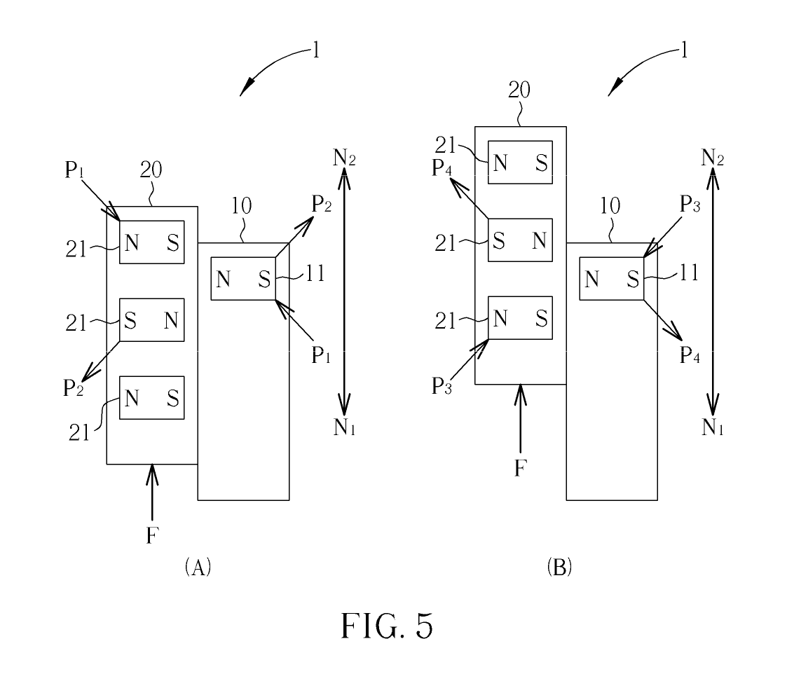

Please refer to FIG. 5. The portions A and B illustrate corresponding statuses of the attractive force or the repulsive force between the magnetic elements 11, 21 of the two housings 10, 20 when the second housing 20 of the handheld device 1 is pushed to different statuses by the outer force. As the first magnetic element 11 slides in the second housing 20, the first magnetic element 11 approaches, departs or faces the second magnetic elements 21 with the same or opposite polarities so as to generate the repulsive force or the attractive force and make the second housing 20, such that the first housing 10 and the second housing 20 are unable to stay in a stable status in either portion A or portion B in FIG. 5 and trend to move to the positions as shown in FIG. 2 or FIG. 4. As shown in the portion A of FIG. 5, when an outer force (pushed by a user) F pushes the second housing 20 to slide along the direction N₂ with respect to the first housing 10, the first magnetic element 11 departs the top stable position facing the second magnetic elements 21. The attractive force generated between each other pushes along the direction P₁, a repulsive force generated between the magnetic element 11 and the second magnetic elements 21 in the middle position pushes along the direction P₂ at the same time. If the external force F disappears at this time, the combined effect of the repulsive force and the attractive force along the direction P₁ and the direction P₂ will drive the second housing 20 along the direction N₂ with respect to the first housing 10 to the closed using position as shown in FIG. 4. If the external force F keeps pushing the second housing 20 along the direction N₂ with respect to the first housing 10 to the position of the portion B as shown in FIG. 5, the first magnetic element 11 approaches the bottom stable position facing the second magnetic elements 21. The attractive force generated between each other pushes along the direction P₃, the repulsive force generated between the first magnetic element 11 and the second magnetic elements 21 in the middle position pushes along the direction P₄ at the same time. If the external force F disappears at this time, the combined effect of the repulsive force and the attractive force along the direction P₁ and the direction P₂ will drive the second housing 20 along the direction N₂ with respect to the first housing 10 to the opened using position as shown in FIG. 2. The closer the first magnetic element 11 gets to the second magnetic element 21 in the middle of the second housing 12 (repulsive to each other due to the same polarity), the more unstable the two housings 10 and 20 become. Therefore, interaction between the first magnetic element 11 and the second magnetic elements 21 with the same and opposite polarities is capable of driving the first housing 10 and the second housing 20 to move to one of the stable using positions.

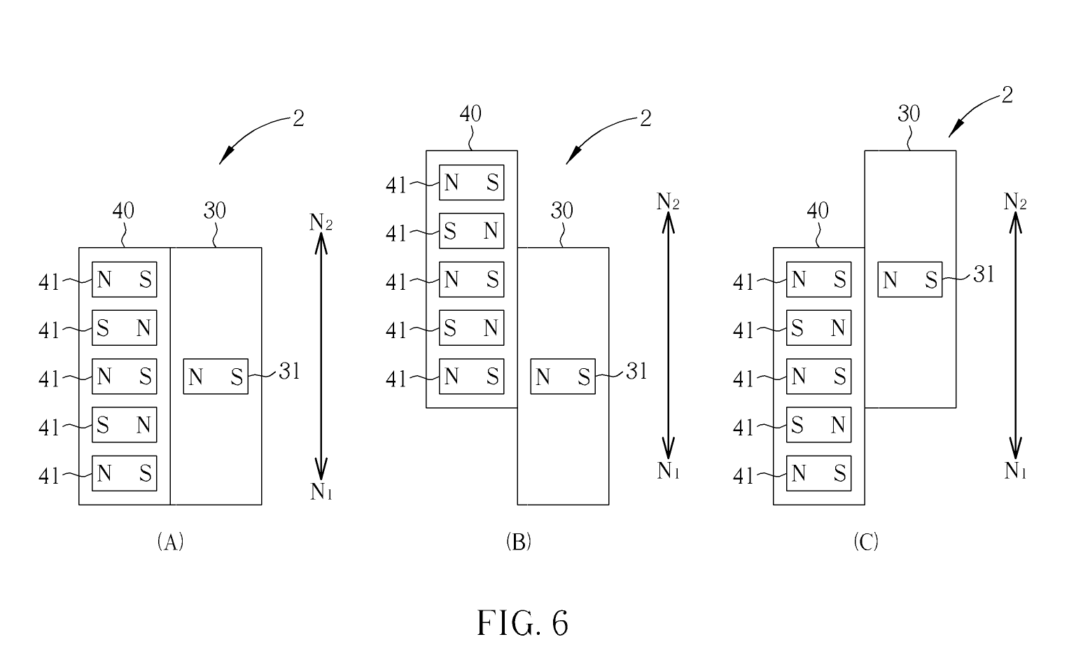

Please refer to FIG. 6. FIG. 6 is a schematic diagram of the handheld device 2 according to a second embodiment in the present invention. In addition to the configuration of the first embodiment, the second embodiment in FIG. 6 shows that the number of the second magnetic elements 41 of the second housing 40 of the handheld device 2 increases to five (the number of the first magnetic element 31 of the first housing 30 is still one and is disposed in the center position) and the second magnetic elements 41 are disposed in a manner facing the first magnetic element 31 with the same and opposite polarities successively. The handheld device 2 of the second embodiment can be designed to have three using statuses (shown in portion A, portion B and portion C of FIG. 6 respectively). In these three using statuses, the first housing 30 and the second housing 40 stay in a stable using position, and the other positions are unstable statuses (not shown). As a result, the handheld device 2 will be driven to have the automatic reversion effect. The detail principle had been described above, so it will not be described herein.

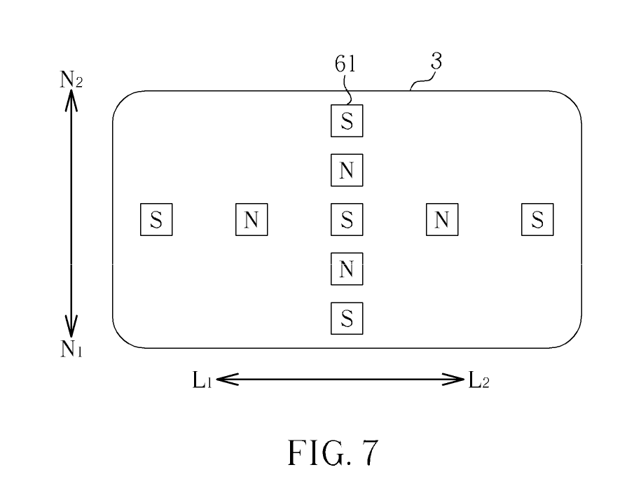

In addition to the first embodiment and the second embodiment, where the housings slide with respect to each other in a straight manner, a third embodiment as shown in FIG. 7 shows that the second magnetic elements 61 of the handheld device 3 may also be aligned in a cross shape along the direction N₁N₂ and the direction L₁L₂ as shown in FIG. 7, where the first magnetic element is not shown in FIG. 7. In this third embodiment, the N pole of the first magnetic element faces the second magnetic elements 61, and each of the second magnetic elements 61 is labeled with the polarity facing one side of the first magnetic element in FIG. 7. Therefore, the second magnetic elements 61 at four ends and the center of the cross shape have polarities opposite to that of the first magnetic element. The handheld device 3 can be set to the status by referring to FIG. 7 that the second housing may be positioned at four using statuses, i.e., upward, downward, leftward and rightward with respect to the first housing.

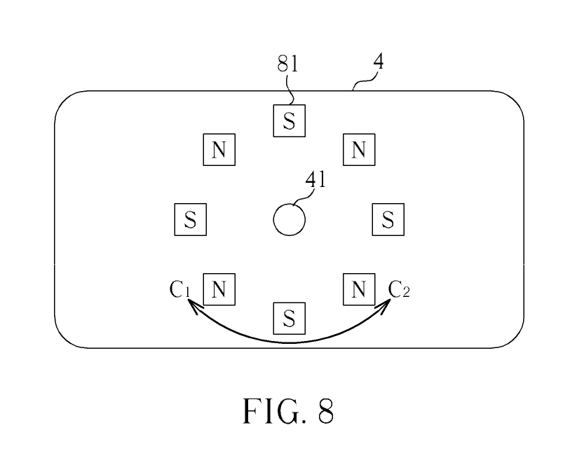

Please refer to FIG. 8. The housings of the handheld device 4 can be rotated with respect to each other around a shaft 41 to have different statuses in the fourth embodiment. The second magnetic elements 81 of the second housing are aligned along an arc C₁C₂ around the shaft 41, as shown in FIG. 8. Therefore, when the housings of the handheld device 4 are rotated with respect to each other, the repulsive force and the attractive force between the second magnetic element 81 and the first magnetic element (not shown) drive the second housing of the handheld device 4 to automatically reverse to the statuses that stand for rotations of 0 degree, 90 degree, 180 degree and 270 degree with respect to the first housing. As a result, different applications of using statuses may be performed in the handheld device 4.

The aforementioned first magnetic elements 11, 31 and the second elements 21, 41, 61, 81 are preferably NdFeB magnets. The automatic reversion function may be performed by utilizing the magnetic elements that take up quite small areas in the handheld device. The larger opening level of the two housings with respect to each other, the larger attractive force between the magnetic elements, while the handheld device is still steadily supported in the opened status. The above embodiments describe the aligning ways of the second magnetic elements 21, 41, 61, 81, which cooperate with the position of the first magnetic element and the slideway manners between the two housings, and should not be limitation of the aligning types of the magnetic elements of the present invention.

The handheld devices of each embodiment disclosed in the present invention have the first housing slidable with respect to the second housing and positioned at different positions corresponding to different using statuses. The first housing includes the first magnetic element, and the second housing includes a plurality of second magnetic elements disposed in a manner and facing the first magnetic element with the same and opposite polarities successively. When the second housing slides with respect to the first housing at a position that the first magnetic element faces the second magnetic elements with opposite polarity, the handheld device is disposed in a corresponding using status. During the sliding of the second housing with respect to the first housing, the repulsive force between two magnetic elements with same polarity causes unstable status between the two housings and pushes the first and the second housings to a stable using status.

Those skilled in the art will readily observe that numerous modifications and alterations of the device and method may be made while retaining the teachings of the invention.

What is claimed is:

1. A handheld device having a plurality of using statuses, the handheld device comprising:
a first housing comprising a first magnetic element; and
a second housing, the first housing assembling with the second housing in a sliding manner with respect to the second housing along an operating direction, the second housing comprising a plurality of second magnetic elements disposed along the operating direction and opposite to the first magnetic element with identical and opposite polarities successively;
wherein the first housing and the second housing are capable of being configured at a plurality of corresponding using positions according to the using statuses of the handheld device; when the first housing slides along the operating direction with respect to the second housing to a position where the first magnetic element faces one of the second magnetic elements with opposite polarity, the first housing and the second housing are configured at a corresponding using position; when the first housing slides along the operating direction with respect to the second housing to a position where the first magnetic element faces one of the second magnetic elements with identical polarity, the first housing and the second housing are pushed to a using position by magnetic repulsive force.

2. The handheld device of claim 1, wherein the plurality of using statuses of the handheld device comprises an opened status and a closed status of sliding cover.

3. The handheld device of claim 1, wherein the operating direction is a straight direction, the plurality of second magnetic elements aligns along the straight direction, and the second magnetic elements at both ends have polarity opposite to that of the first magnetic element.

4. The handheld device of claim 3, wherein the second housing comprises at least three second magnetic elements.

5. The handheld device of claim 3, wherein the first housing comprises a first slideway, the second housing comprises a second slideway, both the first slideway and the second slideway align along the operating direction, and the first slideway cooperates with the second slideway such that the first housing is slidable with respect to the second housing.

6. The handheld device of claim 1, wherein the operating direction is along a line of a cross shape, the plurality of second magnetic elements aligns in the cross shape, and the second magnetic elements at four ends and the center having polarity opposite to that of the first magnetic element.

7. The handheld device of claim 6, wherein the second housing comprises at least nine second magnetic elements.

8. The handheld device of claim 1, wherein the operating direction is along a tangent line of an arc, the first housing rotating with respect to the second housing around a shaft, and the plurality of second magnetic elements disposed aligns along the arc serving the shaft as a center.

9. The handheld device of claim 1, wherein the first magnetic element and the plurality of second magnetic elements are NdFeB magnets.

10. A handheld device having a plurality of using statuses, the handheld device comprising:
a first housing comprising a first magnetic element; and
a second housing disposed on the first housing in a sliding manner along an operating direction, the second housing comprising a plurality of second magnetic elements disposed along the operating direction with alternating polarities;
wherein the plurality of second magnetic elements having polarities arranged alternatively with respect to the first magnetic element generates attractive and repulsive forces so as to push the first housing and the second housing to a specific position when the first housing slides with respect to the second housing along the operating direction.

11. The handheld device of claim 10, wherein the plurality of using statuses of the handheld device comprises an opened status and a closed status of sliding cover.

12. The handheld device of claim 10, wherein the operating direction is along a straight line, the plurality of second magnetic elements aligns along the operating direction, and the second magnetic elements at both ends have polarity opposite to that of the first magnetic element.

13. The handheld device of claim 12, wherein the second housing comprises at least three second magnetic elements.

14. The handheld device of claim 12, wherein the first housing comprises a first slideway, the second housing comprises a second slideway, both the first slideway and the second slideway align along the operating direction, and the first slideway cooperates with the second slideway such that the first housing is slidable with respect to the second housing.

15. The handheld device of claim 10, wherein the operating direction is along one line of a cross shape, the plurality of second magnetic elements aligns in the cross shape, and the second magnetic elements at four ends and the center have polarity opposite to that of the first magnetic element.

16. The handheld device of claim 15, wherein the second housing comprises at least nine second magnetic elements.

17. The handheld device of claim 10, wherein the operating direction is along a tangent line of an arc, the first housing rotating with respect to the second housing around a shaft, and the plurality of second magnetic elements disposed aligns along the arc serving the shaft as a center.

18. The handheld device of claim 10, wherein the first magnetic element and the plurality of second magnetic elements are NdFeB magnets.
